(19) United States
(12) Patent Application Publication
(10) Pub. No.: US 2013/0051481 A1
(43) Pub. Date: Feb. 28, 2013

(54) ELECTRIC POWER-SUPPLY APPARATUS AND RECEIVING APPARATUS

(71) Applicant: Susumu Tsuchida, Tokyo (JP)

(72) Inventor: Susumu Tsuchida, Tokyo (JP)

(73) Assignee: SONY CORPORATION, Tokyo (JP)

(21) Appl. No.: 13/586,366

(22) Filed: Aug. 15, 2012

(30) Foreign Application Priority Data
Aug. 30, 2011 (JP) 2011-186746

(51) Int. Cl. H04B 3/54

(52) U.S. Cl. 375/257

(57) ABSTRACT

An electric power supply apparatus includes a power-supply unit that supplies LNB driving electric power through an electric power line to an LNB (Low Noise Block down converter) in compliance with the DiSEqC (Digital Satellite Equipment Control) standard; a transmission unit that transmits a control command for a DiSEqC apparatus through the electric power line; a receiving unit that receives a response from the DiSEqC apparatus corresponding to the control command through the electric power line; and a suppression unit that suppresses a level of noise that can occur in response to a switching of the switching unit that switches between a TX mode in which the control command is transmitted and an RX mode in which a response is received.

### CROSS-REFERENCE TO RELATED APPLICATION

The present application claims priority from Japanese Patent Application No. JP 2011-186746 filed in the Japanese Patent Office on Aug. 30, 2011, the entire content of which is incorporated herein by reference.

### BACKGROUND

The present disclosure relates to an electric power-supply apparatus and a receiving apparatus. More particularly, the present disclosure relates to an electric power-supply apparatus suitable for use in a case where electric power is supplied to a low noise block (LNB) down converter of a parabolic antenna in compliance with, for example, digital satellite equipment control (DiSEqC) Ver. 2.0 standard, and to a receiving apparatus.

At present, digital television broadcasts transmitted via satellites have been becoming increasingly popular.

In particular, in Europe, a plurality of different satellites for digital television broadcasts have been launched, and the current situation is that a plurality of digital television signals that are broadcast through different respective satellites can be received at the same spot. For this reason, in Europe, also, in general consumer households, (the digital television signals transmitted from) the satellites are selectively switched from the receiving apparatus side, and television programs are received.

Specifically, the receiving apparatus side in compliance with the DiSEqC Ver. 2.0 standard bidirectionally communicates a control signal with an RF selection apparatus of the DiSEqC standard (hereinafter referred to as a DiSEqC apparatus) that selectively switches between LNBs provided in a plurality of respective parabolic antennas, so that satellites from which signals are received are switched between.

Furthermore, the receiving apparatus side in compliance with the DiSEqC Ver. 2.0 standard also supplies LNB driving electric power to the LNB of the parabolic antenna.

FIG. 1 illustrates an example of the configuration of a receiving apparatus of the related art in compliance with the DiSEqC Ver. 2.0 standard. This receiving apparatus 10 is provided as a single body, and is also installed into a television receiver, a video recorder, or the like.

The receiving apparatus 10 is mainly formed of a tuner 11, an MPEG-2 decoding unit 18, a video signal processing unit 19, and a DC power-supply unit 20.

The tuner 11 includes an antenna I/F 12, a high-frequency choke coil 13, a capacitor 14, an amplifier 15, a zero IF conversion unit 16, and a phase shift keying (PSK) demodulation unit 17.

The antenna I/F 12 is connected to an LNB 2 of the parabolic antenna 1 by using an antenna cable, and inputs, to the tuner 11, a Sat-IF signal of 1 to 2 GHz, which is reflected and converged by the parabolic antenna 1 and which is converted from an RF signal (digital television signal) of a 12 GHz band by the LNB 2. Furthermore, the antenna I/F 12 outputs LNB driving electric power that is supplied through the high-frequency choke coil 13 from the DC power-supply unit 20 to the LNB 2.

The high-frequency choke coil 13 prevents leakage of the Sat-IF signal that is input to the tuner 11 from the antenna I/F 12 to the DC power-supply unit 20 side. The capacitor 14 removes the DC components of the Sat-IF signal and outputs the signal to the amplifier 15. The amplifier 15 amplifies the Sat-IF signal in which the DC components are removed and outputs the signal to the zero IF conversion unit 16.

The zero IF conversion unit 16 frequency-converts the Sat-IF signal into an IQ orthogonal signal of the baseband and outputs the signal to the PSK demodulation unit 17 by using a digital/tuning circuit for station selection, which is formed of a built-in PLL synthesizer. The PSK demodulation unit 17 performs PSK demodulation including error correction on the IQ orthogonal signal, and outputs a transport stream (TS) of the MPEG2 format, which is obtained thereby, to the MPEG-2 decoding unit 18.

The MPEG-2 decoding unit 18 decodes the TS, and outputs the video signal obtained thereby to the video signal processing unit 19. The video signal processing unit 19 performs a predetermined signal process on the input video signal, and outputs the signal to the subsequent stage (display unit, etc.). The decoding result of the MPEG-2 decoding unit 18 contains an audio signal, and this is output to the subsequent stage (speaker, etc.) after the predetermined signal process. The illustration thereof is omitted.

The DC power-supply unit 20 supplies, through the tuner 11 to the LNB 2, LNB driving electric power of DC of a voltage of 18 V when the LNB 2 of the parabolic antenna 1 receives a horizontal polarized wave, and LNB driving electric power of DC of a voltage of 13 V when the LNB 2 of the parabolic antenna 1 receives a vertical polarized wave. Furthermore, the DC power-supply unit 20 transmits a DiSEqC command signal (TX) for a DiSEqC apparatus (not shown) through the tuner 11 and also, receives a DiSEqC command signal (RX) that is sent back through the tuner 11 from the DiSEqC apparatus.

FIG. 2 illustrates an example of the detailed configuration of the DC power-supply unit 20. The DC power-supply unit 20 is constituted by a power-supply unit 31, a tone modulation unit 32, a choke unit 33, a bypass switch 34, a demodulation unit 35, and a control unit 36.

The power-supply unit 31 outputs the LNB driving electric power of DC of a voltage of 18 V or 13 V to the power supply line connected to the tuner 11. The tone modulation unit 32 generates a 22 kHz tone signal as a DiSEqC command signal (TX), and modulates the LNB driving electric power in response to the 22 kHz tone signal.

The choke unit 33 is constituted by a coil (22 μH) and a resistor (15) connected in parallel in compliance with the DiSEqC standard. The control unit 36 causes the bypass switch 34 to be turned on when the bypass switch 34 transmits a DiSEqC command signal (TX) for the DiSEqC apparatus, and causes the bypass switch 34 to be turned off when the bypass switch 34 receives a DiSEqC command signal (RX) from the DiSEqC apparatus. As a result, the 22 kHz tone signal as a DiSEqC command signal (TX), which is transmitted, will be output to the tuner 11 after passing through the bypass switch 34. Furthermore, the 22 kHz tone signal as a DiSEqC command signal (RX), which is received, will be input to the demodulation unit 35 as a result of the flow-into the power-supply unit 31 side being blocked by the choke unit 33.

The demodulation unit 35 demodulates the DiSEqC command signal (RX) to be received, and outputs the signal to the control unit 36. The control unit 36 controls each unit of the DC power-supply unit 20. For example, the control unit 36 outputs, to the bypass switch 34, a TX/RX mode switching signal for switching between the TX mode (transmission mode) and the RX mode (reception mode).

FIG. 3 illustrates an example of the waveform of control data for DiSEqC.

The tone modulation unit 32 adds an odd-number parity to binary data as control data forming various commands, and performs PWM (Pulse Width Modulation) modulation on this data to a pulse width of 0.5 ms (corresponding to 1 of binary data) or 1.0 ms (binary data corresponding to 0 of binary data), thereby generating a 22 kHz tone signal.

For example, in a case where control data of 1 byte of E2h=1110 0010b in hexadecimal notation is to be transmitted, a tone signal having the waveform shown in the figure is transmitted.

FIG. 4 illustrates timing of two-way communication in the DiSEqC Ver. 2.0 standard.

In a case where an RF selection apparatus as a DiSEqC apparatus is to be reset, in the DC power-supply unit 20, the bypass switch 34 is turned on (TX mode), and 3-byte control data formed of E2h, 14h, and 01h is transmitted as a kHz tone signal. After that, in order to immediately switch to the RX mode, the bypass switch 34 is turned off, and waiting for the control data of 22h of 1 byte, which is a response that indicates reset completion, to be transmitted from the selector apparatus as a 22 kHz tone signal, is performed.

### SUMMARY

Since switching is performed from the TX mode (transmission mode) to the RX mode (reception mode) in the manner described above, in a case where the bypass switch 34 is switched instantly from an on state to an off state, the LNB driving electric power passing through the bypass switch 34 in the TX mode flows into the coil (220 μh) of the choke unit 33. Therefore, if the electrical current value flowing through this coil is denoted as I and the differential change amount as dI/dt, a counter-electromotive force in proportion to the electrical current increase amount of [220 μh]×dI/dt will be generated in the power supply line across the coil. This counter-electromotive force will be described specifically.

FIG. 5 illustrates an example of the configuration of an equivalent circuit of the DC power-supply unit 20 in which the bypass switch 34 is considered.

In the figure, an FET T1 corresponds to the bypass switch 34. When the series resistor R4 of the FET T1 is assumed to be 300 m, and the remaining resistance amount R2 of the coil L1 forming the choke unit 33 is assumed to be 600 m, in the TX mode, an LNB driving electric power of approximately 150 mA flows through the FET T1. When switched to the RX mode, this power flows into the coil L1 and, as shown in FIG. 6, is generated as a counter-electromotive force (glitch noise) in the form of a spike of about 1 Vpp.

Since this glitch noise occurs immediately after the kHz tone signal is transmitted, depending on the performance that receives the 22 kHz tone signal of the DiSEqC apparatus, this glitch noise is interpreted as part of a 22 kHz tone signal that falls within the standard value of 650 mVpp±250 mV, and a reception process is continued by assuming that the transmission of the 22 kHz tone signal from the DC power-supply unit 20 is continued even after this.

On the other hand, in the DC power-supply unit 20 of the communication party, the transmission of the 22 kHz tone signal has already been completed. Consequently, in the LNB 2 that continues the reception process, after a predetermined time has passed, this glitch noise is processed as an error, and a situation can arise where a command using the 22 kHz tone signal that has been received before that time is not processed properly. That is, depending on the generation timing of the glitch noise, in the worst case, there may be a situation where two-way communication between the DC power-supply unit 20 and the LNB 2 is not established.

The present disclosure has been made in view of such circumstances, and aims to stably perform two-way communication with a DiSEqC apparatus.

An electric power supply apparatus according to a first embodiment of the present disclosure includes: a power-supply unit that supplies low noise block driving electric power through an electric power line to a low noise block down converter in compliance with the digital satellite equipment control standard; a transmission unit that transmits a control command for a digital satellite equipment control apparatus through the electric power line; a receiving unit that receives a response from the digital satellite equipment control apparatus corresponding to the control command through the electric power line; and a suppression unit that suppresses a level of noise that can occur in response to a switching of the switching unit that switches between a TX mode in which the control command is transmitted and an RX mode in which a response is received.

The electric power-supply apparatus according to the first embodiment of the present disclosure may further include a choke coil that suppresses attenuation of the response from the DiSEqC apparatus through the power supply line, wherein when the switching unit is switched from the TX mode to the RX mode, noise may be a counter-electromotive force that can occur as a result of the LNB driving electric power being made to flow into the choke coil.

The electric power-supply apparatus according to the first embodiment of the present disclosure may further include a control unit that outputs a switching signal for the switching unit, wherein the suppression unit may integrate and delay the switching signal that is output from the control unit and supplies the switching signal to the switching unit, thereby causing the switching unit to be gradually switched from the TX mode to the RX mode.

The switching unit may be formed of a plurality of switches, and the suppression unit may cause the plurality of switches to be switched with a predetermined time difference, thereby switching in a step-like manner from the TX mode to the RX mode.

A receiving apparatus according to a second embodiment of the present disclosure includes a power-supply unit that supplies low noise block driving electric power through an electric power line to a low noise block down converter in compliance with the digital satellite equipment control standard; a tuner that inputs an IF signal that is reflected and converged by a parabolic antenna and that is converted from an RF signal by the low noise block down converter; a transmission unit that transmits a control command for a digital satellite equipment control apparatus through the electric power line; a receiving unit that receives a response from the digital satellite equipment control apparatus corresponding to the control command through the electric power line; and a suppression unit that suppresses a level of noise that can occur in accordance with a switching of the switching unit that switches between a TX mode in which the control command is transmitted and an RX mode in which a response is received.

In the first and second embodiments of the present disclosure, the level of the noise is suppressed in accordance with the switching of the switching unit that switches between the TX mode that transmits a control command and an RX mode that receives a response.

According to the first embodiment of the present disclosure, it is possible to suppress the level of noise that can occur.

According to the second embodiment of the present disclosure, it is possible to stably perform two-way communication with a DiSEqC apparatus.

### BRIEF DESCRIPTION OF THE DRAWINGS

FIG. 1 is a block diagram illustrating an example of the configuration of a receiving apparatus of the related art;

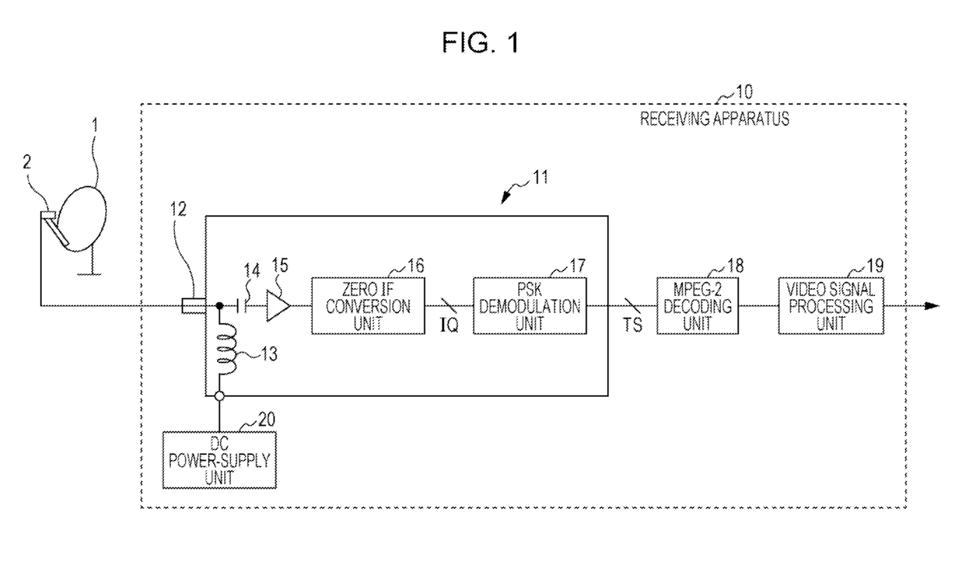

FIG. 2 is a block diagram illustrating an example of the configuration of a DC power-supply unit of FIG. 1;

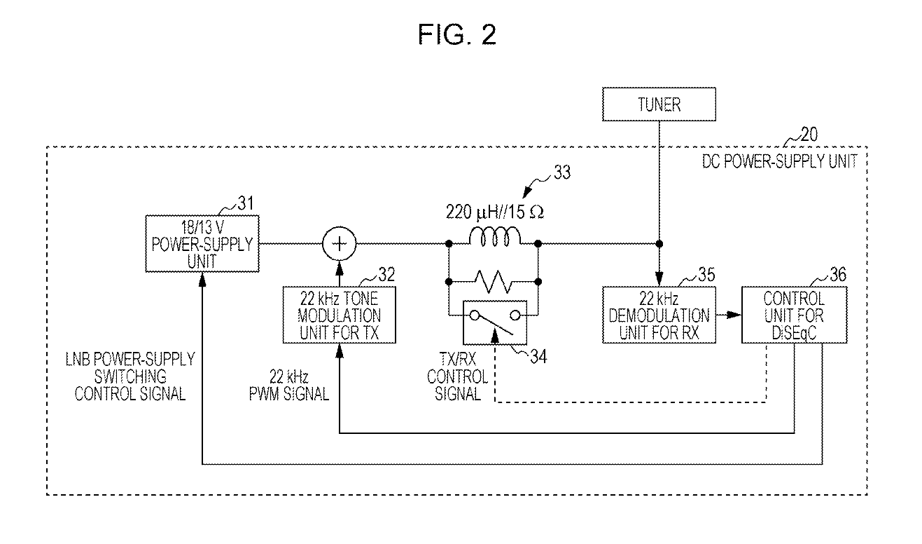

FIG. 3 illustrates an example of a transmission waveform of control data for DiSEqC;

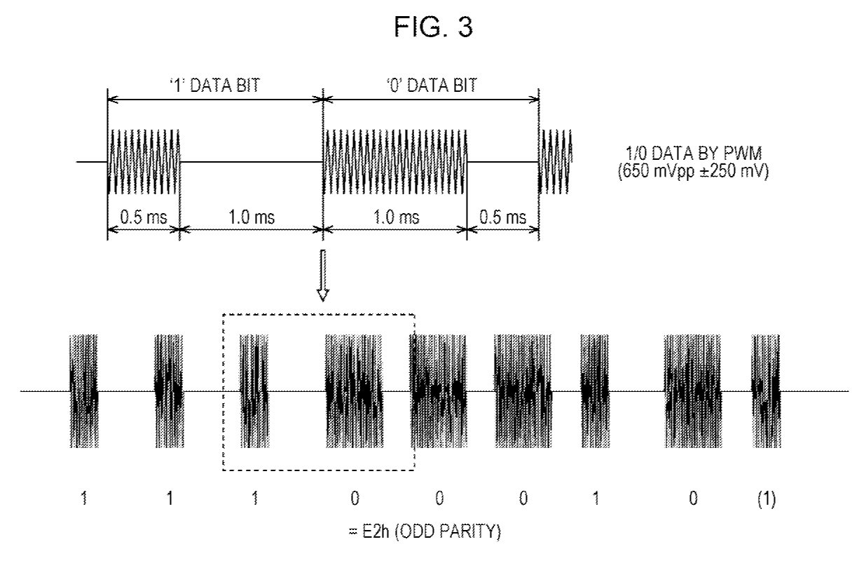

FIG. 4 illustrates timing of two-way communication in the DiSEqC Ver. 2.0 standard;

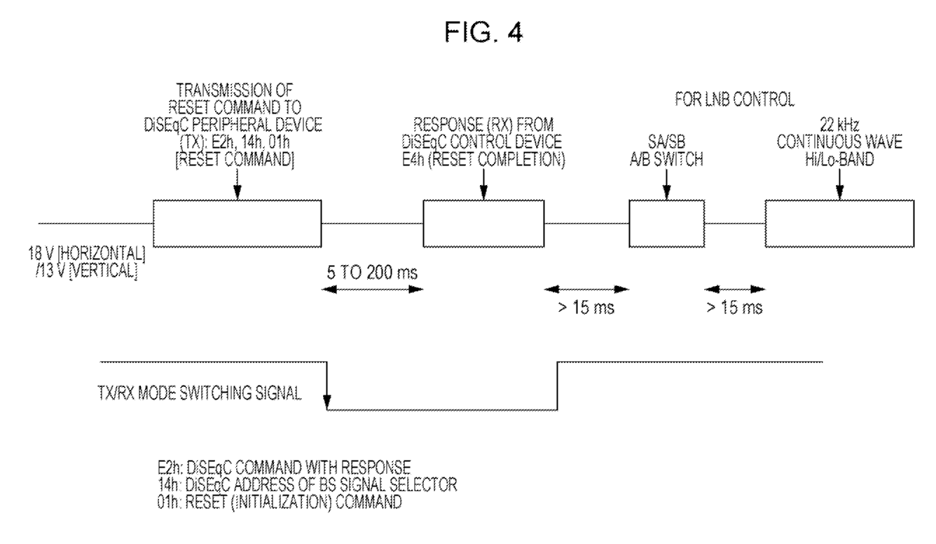

FIG. 5 is a circuit diagram illustrating an example of the configuration of an equivalent circuit of a DC power-supply unit in which a bypass switch is considered according to the related art;

FIG. 6 illustrates glitch noise and the like, which can occur in the equivalent circuit of FIG. 5;

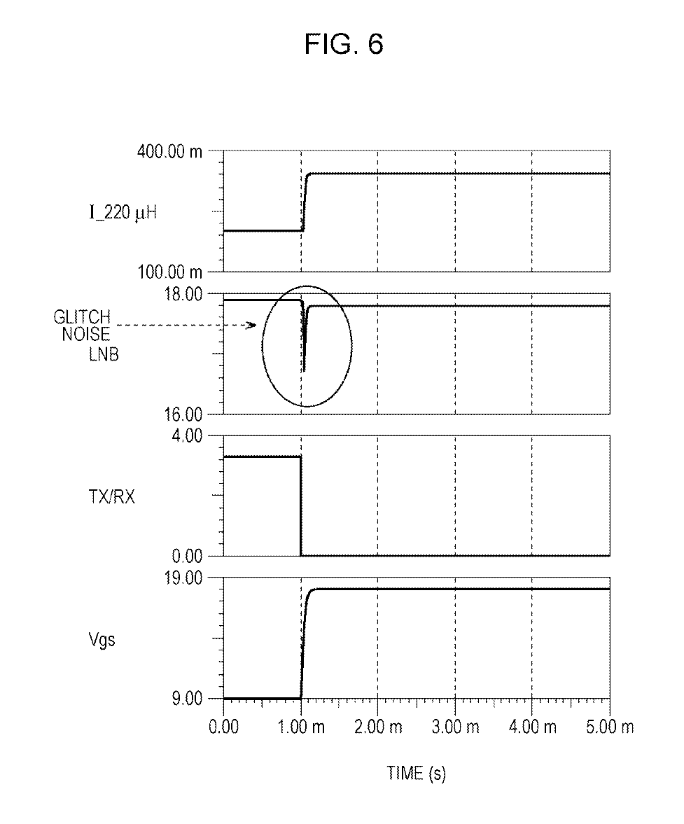

FIG. 7 is a circuit diagram illustrating a first configuration example of a DC power-supply unit according to an embodiment;

FIG. 8 illustrates glitch noise and the like, which can occur from the DC power-supply unit of FIG. 7;

FIG. 9 is a circuit diagram illustrating a second configuration example of a DC power-supply unit according to an embodiment; and

FIG. 10 illustrates glitch noise and the like, which can occur from the DC power-supply unit of FIG. 9.

### DETAILED DESCRIPTION OF EMBODIMENTS

The best mode for embodying the present disclosure (hereinafter referred to as an embodiment) will be described below in detail with reference to the drawings.

### 1. Embodiment

### First Configuration Example of DC Power-Supply Unit

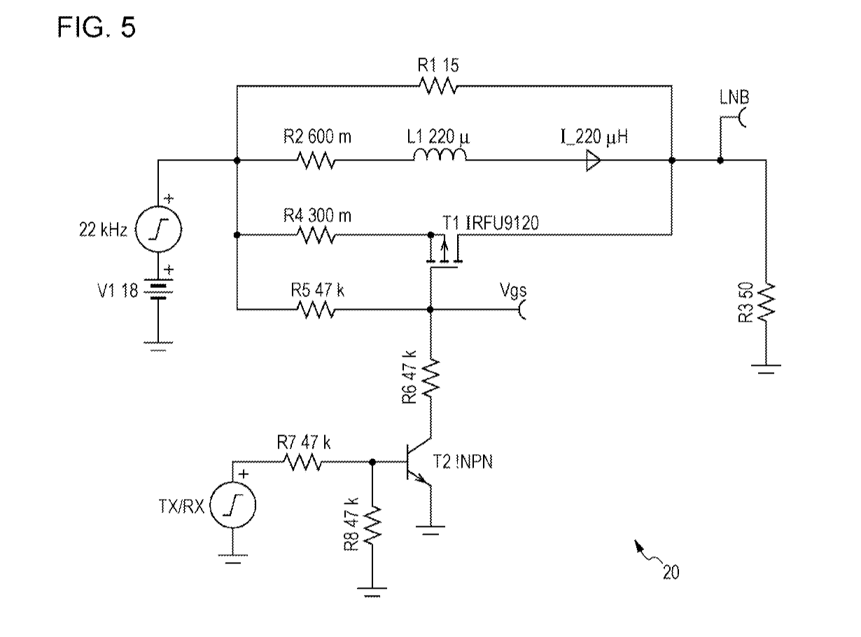

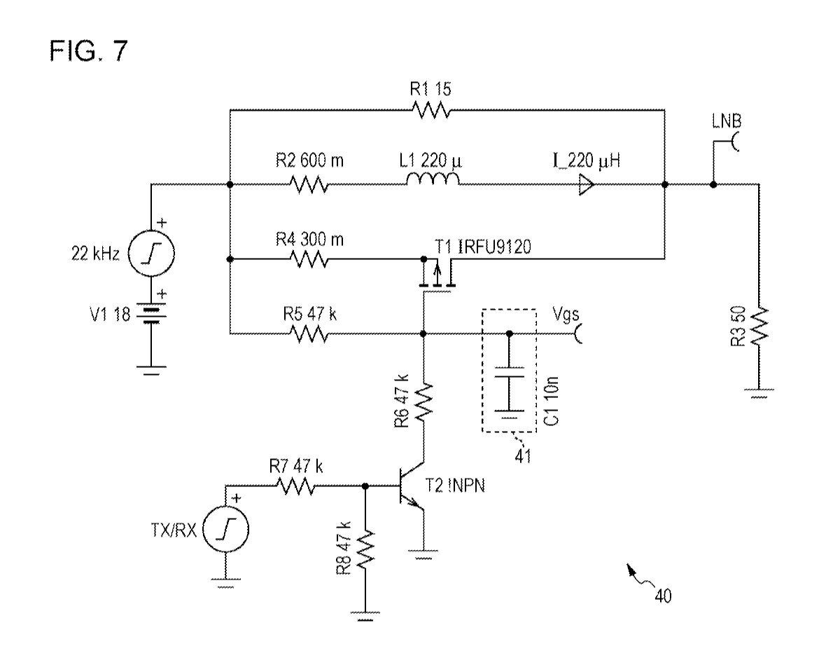

FIG. 7 is a circuit diagram illustrating a first configuration example of a DC power-supply unit according to an embodiment. A DC power-supply unit 40 is used for a receiving apparatus 10 in place of a DC power-supply unit 20 whose equivalent circuit is shown in FIG. 5.

The DC power-supply unit 40 is such that, with respect to the DC power-supply unit 20 of FIG. 5, a capacitor C1 having a capacitance 10 nF indicated using a dashed line 31 is added between the gate terminal of the FET T1 corresponding to the bypass switch 34, and GND. Since the rest of the construction is the same as that of FIG. 5, the description thereof is omitted.

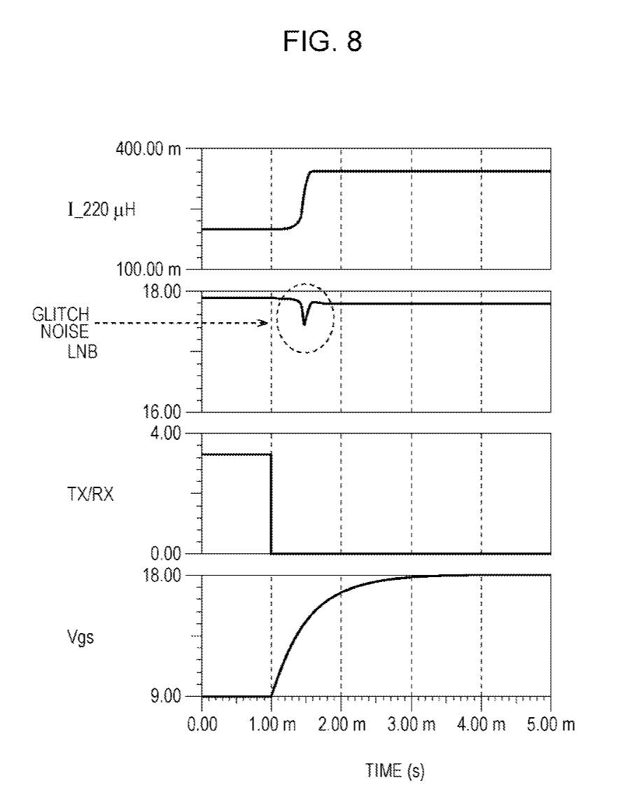

FIG. 8 illustrates glitch noise, and the like, which can originate from the DC power-supply unit 40 shown in FIG. 7.

In the DC power-supply unit 40, as a result of a capacitor C1 being added, a TX/RX mode switching signal from the control unit 36 is integrated and delayed. As a result of this delay, the switching operation of the FET T1 from on to off becomes moderate, and the flow-in speed of the LNB driving electric power into the coil L1 forming the choke unit 33 can be moderated. Therefore, the differential change amount dI/dt of the electrical current value 1 flowing through the coil L1 decreases, and the counter-electromotive force 220 [μHi]×dI/dt that occurs across the coil L1 is reduced.

Specifically, in the case of the equivalent circuit of the DC power-supply unit 40 shown in FIG. 8, the glitch noise in the form of a spike, which occurs in the LNB driving electric power, is suppressed to 250 mVpp, which is smaller than the lower limit standard value 400 mVpp of the 22 kHz tone signal. Consequently, the glitch noise can be suppressed to glitch noise to such a degree as to not be interpreted as part of the 22 kHz tone signal in the DiSEqC apparatus.

### Second Configuration Example of Dc Power-supply Unit

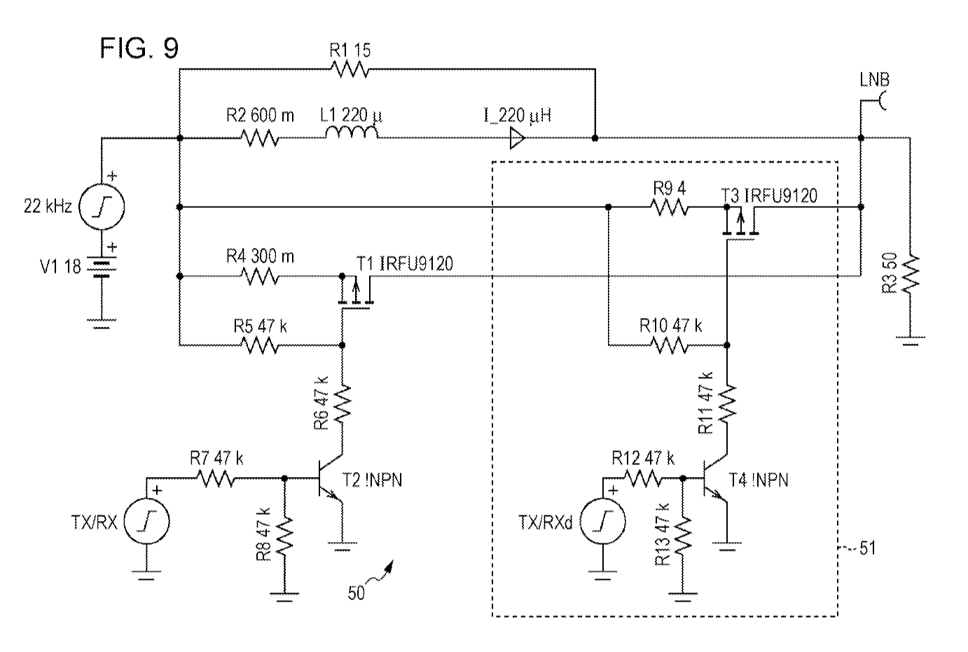

FIG. 9 illustrates a second configuration example of a DC power-supply unit according to an embodiment. This DC power-supply unit 50 is used for the receiving apparatus 10 in place of the DC power-supply unit 20 whose equivalent circuit is shown in FIG. 5. The DC power-supply unit 50 is such that an FET T3 or the like encircled by the dashed line 51 is added to the DC power-supply unit 20 of FIG. 5, and the rest of the configuration is the same as that of FIG. 5. Thus, the description thereof is omitted.

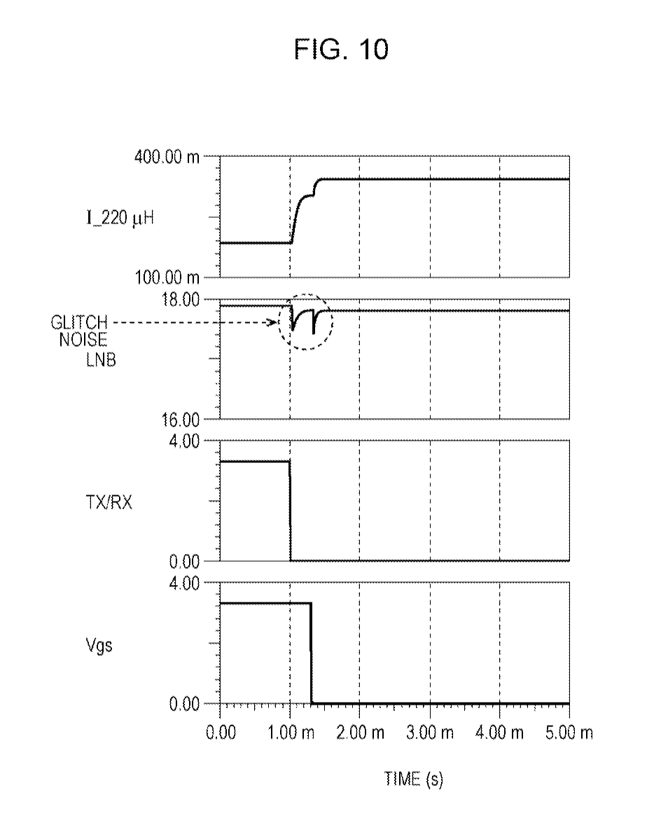

FIG. 10 illustrates glitch noise and the like, which can occur from the DC power-supply unit 50 shown in FIG. 9.

In the DC power-supply unit 50, the FET T1 and the FET T2, which are connected in parallel, correspond to the bypass switch 34. The FET T3 is configured to be turned off in accordance with the switching pulse RX/TXd by being delayed by 300 ms from the timing at which the FET T1 is turned off in accordance with the switching pulse RX/TX. For example, in order to distribute the LNB driving electric power so that an electrical current of about 70% of the LNB driving electric power flows into the FET T1, and an electrical current of about 30% flows into the FET T3, it is sufficient that the series resistor R9 of the FET T3 be set at 4.

In the case of the DC power-supply unit 50, even if switching is performed from the TX mode to the RX mode, LNB driving electric power does not suddenly flow into the coil L1 forming the choke unit 33. Therefore, glitch noise in the form of a spike, which occurs in the electric power line, can be suppressed to spike/noise components of approximately 250 mVpp, which is smaller than the lower limit standard value 400 mVpp of the 22 kHz tone signal. That is, in the DiSEqC apparatus, the glitch noise can be suppressed to glitch noise to such a degree as to not be interpreted as part of the 22 kHz tone signal.

Furthermore, in the case of the DC power-supply unit 50, by only delaying the switching pulse TX/RX for the FET T1 by a typical latch circuit, a switching pulse TX/RXd for the FET T3 can be obtained. Thus, it is possible to reduce the circuit scale of the entire DC power-supply unit 50.

In the DC power-supply unit 50, the bypass switch is realized by using FETs of two stages. Alternatively, the bypass switch may be realized by FETs of many stages.

In the DC power-supply unit 40 or 50 described in the foregoing, it is possible to suppress glitch noise that can occur when switched from the TX mode to the RX mode to the lower limit standard value of the 22 kHz tone signal of 400 mVpp or less.

Therefore, if the DC power-supply unit 40 or 50 is adopted as the receiving apparatus of digital television broadcast, it becomes possible to realize stable two-way communication between the receiving apparatus and the DiSEqC apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. An electric power supply apparatus comprising:
a power-supply unit that supplies low noise block driving electric power through an electric power line to a low noise block down converter in compliance with the digital satellite equipment control standard;
a transmission unit that transmits a control command for a digital satellite equipment control apparatus through the electric power line;
a receiving unit that receives a response from the digital satellite equipment control apparatus corresponding to the control command through the electric power line; and
a suppression unit that suppresses a level of noise that can occur in response to a switching of the switching unit that switches between a TX mode in which the control command is transmitted and an RX mode in which a response is received.

2. The electric power-supply apparatus according to claim 1, further comprising a choke coil that suppresses attenuation of the response from the digital satellite equipment control apparatus through the power supply line,
wherein when the switching unit is switched from the TX mode to the RX mode, noise is a counter-electromotive force that can occur as a result of the low noise block driving electric power being made to flow into the choke coil.

3. The electric power-supply apparatus according to claim 2, further comprising a control unit that outputs a switching signal for the switching unit,
wherein the suppression unit integrates and delays the switching signal that is output from the control unit and supplies the switching signal to the switching unit, thereby causing the switching unit to be gradually switched from the TX mode to the RX mode.

4. The electric power-supply apparatus according to claim 2,
wherein the switching unit is formed of a plurality of switches, and
wherein the suppression unit causes the plurality of switches to be switched with a predetermined time difference, thereby switching in a step-like manner from the TX mode to the RX mode.

5. A receiving apparatus comprising:
a power-supply unit that supplies low noise block driving electric power through an electric power line to a low noise block down converter in compliance with the digital satellite equipment control standard;
a tuner that inputs an IF signal that is reflected and converged by a parabolic antenna and that is converted from an RF signal by the low noise block down converter;
a transmission unit that transmits a control command for a digital satellite equipment control apparatus through the electric power line;
a receiving unit that receives a response from the digital satellite equipment control apparatus corresponding to the control command through the electric power line; and
a suppression unit that suppresses a level of noise that can occur in accordance with a switching of the switching unit that switches between a TX mode in which the control command is transmitted and an RX mode in which a response is received.
